(19) United States
(12) Patent Application Publication
(10) Pub. No.: US 2022/0043697 A1
(43) Pub. Date: Feb. 10, 2022

(54) SYSTEMS AND METHODS FOR ENABLING INTERNAL ACCELERATOR SUBSYSTEM FOR DATA ANALYTICS VIA MANAGEMENT CONTROLLER TELEMETRY DATA

(71) Applicant: Dell Products L.P., Round Rock, TX (US)

(72) Inventors: Chitrak GUPTA, Bangalore (IN); Rama Rao BISA, Bangalore (IN); Pavan Kumar GAVVALA, Bagalore (IN)

(73) Assignee: Dell Products L.P., Round Rock, TX (US)

(21) Appl. No.: 16/986,705

(22) Filed: Aug. 6, 2020

(51) Int. Cl. G06F 9/54; G06F 11/00

(52) U.S. Cl. CPC G06F 9/542; G06F 11/004

(57) ABSTRACT

An information handling system may include a processor, a management controller configured for out-of-band management of the information handling system, and an internal accelerator communicatively coupled to the management controller and configured to execute an analytics engine for receiving events from the management controller and analyzing the events to perform one or more tasks based on the events.

### TECHNICAL FIELD

The present disclosure relates in general to information handling systems, and more particularly to methods and systems for deploying an operating system to a smart network interface card and lifecycle management of the network interface card.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Using traditional approaches, a management controller of an information handling system may monitor multiple attributes of server hardware components such as solid state drives, network interface cards, and other components, and communicate events to a remote server. The remote server may read and analyze such events in order to perform predictive failure analysis, provide notifications, and/or perform other tasks. In such approaches, the remote server is needed, as the management controller may not possess necessary processing capacity to perform the tasks performed by the remote server. However, many users are not comfortable in having system data and events communicated over a network due to data privacy concerns.

### SUMMARY

In accordance with the teachings of the present disclosure, the disadvantages and problems associated with processing telemetry data may be reduced or eliminated.

In accordance with embodiments of the present disclosure, an information handling system may include a processor, a management controller configured for out-of-band management of the information handling system, and an internal accelerator communicatively coupled to the management controller and configured to execute an analytics engine for receiving events from the management controller and analyzing the events to perform one or more tasks based on the events.

In accordance with these and other embodiments of the present disclosure, an internal accelerator configured to couple to a management controller configured for out-of-band management of an information handling system, the internal accelerator further configured to execute an analytics engine for receiving events from the management controller and analyzing the events to perform one or more tasks based on the events.

In accordance with these and other embodiments of the present disclosure, a method may include, in an information handling system comprising a management controller configured for out-of-band management of the information handling system, executing, by an internal accelerator communicatively coupled to the management controller, an analytics engine for receiving events from the management controller and analyzing the events to perform one or more tasks based on the events.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for enabling data analytics using an internal accelerator, in accordance with embodiments of the present disclosure; and

FIG. 2 illustrates a block diagram of an example method for enabling data analytics using an internal accelerator, in accordance with embodiments of the present disclosure.

### DETAILED DESCRIPTION

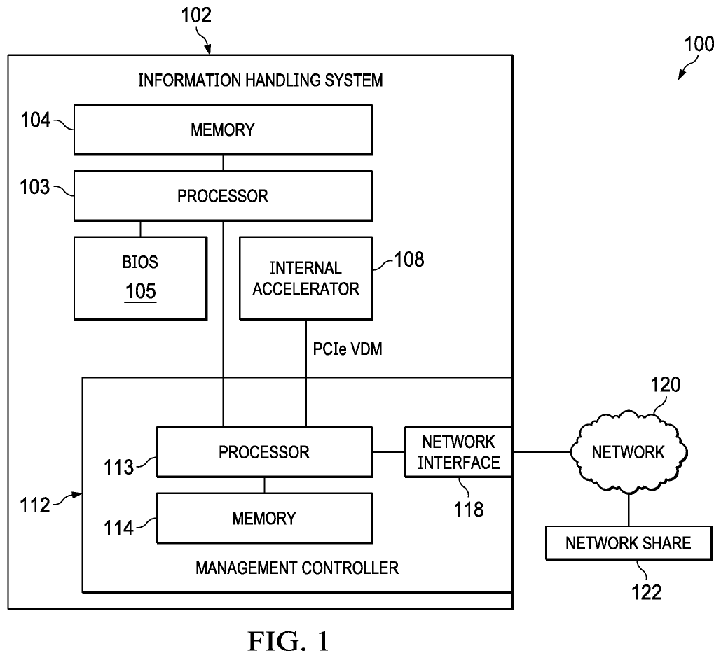

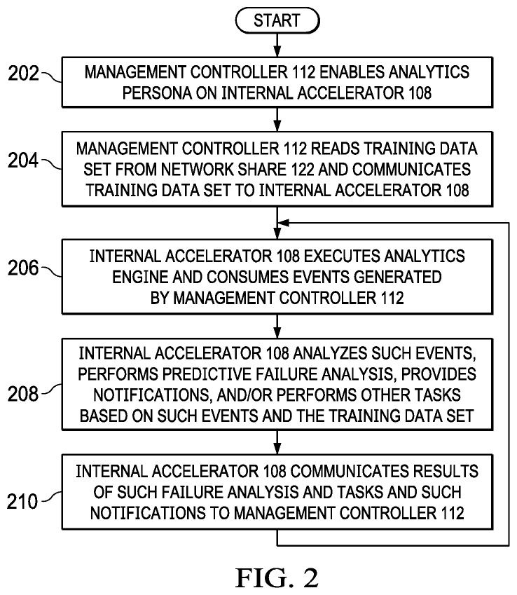

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 for enabling data analytics using an internal accelerator, in accordance with embodiments of the present disclosure. As shown in FIG. 1, system 100 may include an information handling system 102, a network 120, and a network share 122.

In some embodiments, information handling system 102 may comprise or be an integral part of a server. In other embodiments, information handling system 102 may be a personal computer. In these and other embodiments, information handling system 102 may be a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a basic input/output (BIOS) system 105 communicatively coupled to processor 103, a management controller 112 communicatively coupled to processor 103, and an internal accelerator 108 communicatively coupled to management controller 112.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., memory 104) may be executed by processor 103 and given control of information handling system 102.

Management controller 112 may be configured to provide out-of-band management facilities for management of information handling system 102. Such management may be made by management controller 112 even if information handling system 102 is powered off or powered to a standby state. Management controller 112 may include a processor 113, memory 114, and an out-of-band network interface 118. In certain embodiments, management controller 112 may include or may be an integral part of a baseboard management controller (BMC), a remote access controller (e.g., a Dell Remote Access Controller or Integrated Dell Remote Access Controller), or an enclosure controller. In other embodiments, management controller 112 may include or may be an integral part of a chassis management controller (CMC).

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in memory 114 and/or another component of information handling system 102 or management controller 112.

Memory 114 may be communicatively coupled to processor 113 and may include any system, device, or apparatus configured to retain program instructions and/or data for a period of time (e.g., computer-readable media). Memory 114 may include RAM, EEPROM, a PCMCIA card, flash memory, magnetic storage, opto-magnetic storage, or any suitable selection and/or array of volatile or non-volatile memory that retains data after power to management controller 112 is turned off. Memory 114 may have stored thereon software and/or firmware which may be read and executed by processor 113 for carrying out the functionality of management controller 112.

Network interface 118 may comprise any suitable system, apparatus, or device operable to serve as an interface between management controller 112 and/or one or more other information handling systems. Network interface 118 may enable management controller 112 to communicate using any suitable transmission protocol and/or standard. In these and other embodiments, network interface 118 may comprise a network interface card, or “NIC.”

Internal accelerator 108 may be coupled to processor 113 of management controller 112 via any suitable interface (e.g., a Peripheral Component Interconnect Express Vendor Defined Message (PCIe VDM) interface), and may comprise any suitable system, apparatus, or device operable to read and analyze events associated with management controller 112 and based on such events, perform predictive failure analysis, provide notifications, and/or perform other tasks, as described in greater detail below. In some embodiments, internal accelerator 108 may be implemented as a field programmable gate array (FPGA).

In addition to processor 103, memory 104, BIOS 105, management controller 112, and internal accelerator 108, information handling system 102 may include one or more other information handling resources.

Network 120 may comprise a network and/or fabric configured to couple information handling system 102 and network share 122 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

Network share 122 may comprise an information handling system, and may include any system, device, or apparatus configured to store or otherwise maintain a training data set defining parameters and/or policies by which internal accelerator 108 may analyze events, predict failures based on such events, provide notifications, and/or perform other tasks, as described in greater detail below.

In operation, management controller 112 may read a training data set from network share 122 and communicate the training data set to internal accelerator 108. Management controller 112 may also enable an analytics persona on internal accelerator 108, wherein such analytics persona may execute an application needed to execute an analytics engine on internal accelerator 108. In some embodiments, management controller 112 may enable multiple personas on internal accelerator 108, to allow internal accelerator 108 to execute multiple analytics operations. While executing the analytics engine, internal accelerator 108 may consume events generated by management controller 112, analyze such events, and perform predictive failure analysis, provide notifications, and/or perform other tasks based on such events and the training data set. Further, internal accelerator 108 may communicate results of such failure analysis and tasks and such notifications to management controller 112, which may further handle or process such information accordingly.

In some embodiments, multiple management controllers coupled to network 120 may contribute to the training data set ultimately provided to internal accelerator 108.

Using the novel approach described herein, management controller 112 may leverage an add-in shared or dedicated internal accelerator 108, either of which might not have access to network share 122, and thus management controller 112 may provide the whole range of internal accelerator 108 setup and input requirements.

FIG. 2 illustrates a block diagram of an example method 200 for enabling data analytics using internal accelerator 108, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, management controller 112 may enable an analytics persona on internal accelerator 108, wherein such analytics persona may execute an application needed to execute an analytics engine on internal accelerator 108. At step 204, management controller 112 may read a training data set from network share 122 and communicate the training data set to internal accelerator 108. At step 206, internal accelerator 108 may execute the analytics engine and consume events generated by management controller 112. At step 208, internal accelerator 108 may analyze such events, and perform predictive failure analysis, provide notifications, and/or perform other tasks based on such events and the training data set. At step 210, internal accelerator 108 may communicate results of such failure analysis and tasks and such notifications to management controller 112, which may further handle or process such information accordingly. After completion of step 210, method 200 may proceed again to step 206.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 102 or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
a management controller configured for out-of-band management of the information handling system; and
an internal accelerator communicatively coupled to the management controller and configured to execute an analytics engine for:
receiving events from the management controller; and
analyzing the events to perform one or more tasks based on the events.

2. The information handling system of claim 1, wherein the one or more tasks comprise one or more of predictive failure analysis and communication of notifications.

3. The information handling system of claim 1, wherein the internal accelerator is implemented using a field-programmable gate array.

4. The information handling system of claim 1, wherein the management controller is further configured to enable an analytics persona on the internal accelerator that enables the internal accelerator to execute the analytics engine.

5. The information handling system of claim 1, wherein the management controller is further configured to:
obtain training data from a network share communicatively coupled to the management controller; and
communicate the training data to the internal accelerator for use in executing the analytics engine.

6. The information handling system of claim 1, wherein the management controller is further configured to enable multiple analytics personas on the internal accelerator, to allow the internal accelerator to execute multiple analytics operations.

7. The information handling system of claim 1, wherein functionality of the internal accelerator is shared by the management controller and at least one other information handling resource.

8. An internal accelerator configured to couple to a management controller configured for out-of-band management of an information handling system, the internal accelerator further configured to execute an analytics engine for:
receiving events from the management controller; and
analyzing the events to perform one or more tasks based on the events.

9. The internal accelerator of claim 8, wherein the one or more tasks comprise one or more of predictive failure analysis and communication of notifications.

10. The internal accelerator of claim 8, wherein the internal accelerator is implemented using a field-programmable gate array.

11. The internal accelerator of claim 8, wherein the internal accelerator is configured such that the management controller enables an analytics persona on the internal accelerator that enables the internal accelerator to execute the analytics engine.

12. The internal accelerator of claim 8, further configured to obtain training data from the management controller for use in executing the analytics engine, wherein the management controller obtains the training data from a network share communicatively coupled to the management controller.

13. The internal accelerator of claim 8, wherein the internal accelerator may include multiple analytics personas, to allow the internal accelerator to execute multiple analytics operations.

14. The internal accelerator of claim 8, wherein functionality of the internal accelerator is shared by the management controller and at least one other information handling resource of the information handling system.

15. A method comprising, in an information handling system comprising a management controller configured for out-of-band management of the information handling system, executing, by an internal accelerator communicatively coupled to the management controller, an analytics engine for:
receiving events from the management controller; and
analyzing the events to perform one or more tasks based on the events.

16. The method of claim 15, wherein the one or more tasks comprise one or more of predictive failure analysis and communication of notifications.

17. The method of claim 15, wherein the internal accelerator is implemented using a field-programmable gate array.

18. The method of claim 15, further comprising enabling, by the management controller, an analytics persona on the internal accelerator that enables the internal accelerator to execute the analytics engine.

19. The method of claim 15, further comprising obtaining, by the internal accelerator, training data from the management controller for use in executing the analytics engine, wherein the management controller obtains the training data from a network share communicatively coupled to the management controller.

20. The method of claim 15, further comprising enabling, by the management controller, multiple analytics personas on the internal accelerator, to allow the internal accelerator to execute multiple analytics operations.

21. The method of claim 15, further comprising sharing functionality of the internal accelerator by the management controller and at least one other information handling resource.
